(19) United States
(12) Patent Application Publication
(10) Pub. No.: US 2018/0082232 A1
(43) Pub. Date: Mar. 22, 2018

(54) UNIFORM WORKERS COMPENSTATION COST CONTAINMENT SYSTEM

(71) Applicants: Elizabeth Howard, Van Nuys, CA (US); Brian Stalker, Van Nuys, CA (US)

(72) Inventors: Elizabeth Howard, Van Nuys, CA (US); Brian Stalker, Van Nuys, CA (US)

(73) Assignee: CostFirst Corp., Van Nuys, CA (US)

(21) Appl. No.: 15/272,817

(22) Filed: Sep. 22, 2016

(51) Int. Cl. G06Q 10/06

(52) U.S. Cl. CPC G06Q 10/06313; G06Q 10/063118

(57) ABSTRACT

A uniform workers' compensation cost containment computing system for creating a strategic plan for resolving all aspects of a one or more than one claim in an efficient manner and maximizing savings comprising one or more than one processor communicatively coupled to a storage that has instructions to: display a graphical user interface dashboard, where the user can be local or remote, a global module, a claims module, a user module, a tracking module, a document module, a calendar module, and a reporting module.

### CROSS-REFERENCE TO RELATED APPLICATIONS

This Application claims the benefit under 35 U.S.C. § 119(e) of U.S. Provisional Patent Application Ser. No. 62/222,127, filed on Sep. 22, 2015, the contents of which are incorporated herein by reference in their entirety.

### FIELD OF THE INVENTION

The present invention relates to workers' compensation claims, and more specifically to a uniform workers' compensation cost containment system for creating a strategic and management plan for resolving all aspects of a one or more than one claim in an efficient manner and maximizing savings.

### BACKGROUND

Currently, workers' compensation claims are handled in a variety of ways. From pen and paper to exotic Excel spreadsheets. These methods do not provide a consistent, verifiable outcome for insurance providers, third party administrators, and employers. Depending on the skill and experience of the person doing the calculations, the results can vary wildly from case to case. Disadvantageously, using current methods also compounds the problem of tracking claims through the entire process leading to delays that can cost both the insurance carrier and the employer. The judges at the workers' compensation hearings want a fair and balanced end to all the claims that come before them, but are left with questions that they must answer due to the inaccuracies of the current system.

Therefore, there is a need for a uniform workers compensation cost containment system for creating a strategic plan for resolving all aspects of a one or more than one claim in an efficient manner and maximizing savings.

### SUMMARY

The present invention solves the problems with the prior art by providing a uniform workers' compensation cost containment computing system for creating a strategic plan for resolving all aspects of a one or more than one claim in an efficient manner and maximizing savings. The computing system comprises one or more than one processor and a storage communicatively coupled to the one or more than one processor comprising instructions. When executed by the one or more than one processor, the instructions for the system display a graphical user interface dashboard, where a user is selected from the group consisting of a local user and a remote user. Additionally, there are instructions stored in the storage and executable on the processor for a global module, a claims module, a user module, a tracking module, a document module, a calendar module and a reporting module.

The data displayed on the dashboard is based on the user's respective activities and permissions. The dashboard can be displayed via a web browser.

The global module comprises instructions executable on the one or more than one processor to access the storage and to track and authenticate users, groups, and administrators. The global module also has instructions for data migration of existing bill log data to be imported into the system, layout design specifications for the client to select required or preferred colors/color schemes and screen resolution(s); global navigation of the dashboard using a displayed header; and local navigation using a sidebar.

The claims module comprises tables stored in the storage to manage core data needed to track and manage clients, contacts, liens and claims. This includes the providers and staff that are associated with the core data. The claims module further comprises executable instructions to display layouts for the data. The layouts can be a claims list view of all claim records in the system and a claims table that contains developer layout that will have all claims fields. The claims module also has instructions executable on the one or more than one processor to add a new claim by creation of new claim record, upload claim documents, view claim documents, request a provider, import liens, advance the claim to another department, display a bills portal for related bill records, a claim notes portal to display claim notes records, a companion claims portal to display related companion claim records, a product select portal, where the user can select available products for this claim, a call log portal to display related call log records, an automatic plan of action generator, a bill log portal that displays related bill log records, a status assignment for the claim, and a claim notes table, where the claim notes table comprises data relevant to the claim note.

The user module comprises instructions executable on the one or more than one processor to add a new staff record, assign a role to staff member, assign a privilege set, where the privilege set controls the level of user access to the system, create a password, create an account, remove a user and maintain an activities table that comprises data relevant to a specific activity assigned to a staff member.

The tracking module comprises all data related phone and time tracking for employees, activities, liens and claims.

The document module comprises all the data related documents stored in the system and fields for internal tracking and instructions for automatically building relationships to other tables.

The calendar module comprises all the data related to calendar items for appearances. The data includes a code and a litigation calendar table. The litigation calendar table comprises data relevant to specific calendar entries including: a judge; an assigned representative; total appearances that is a count of appearance records; an outcome; an appearance needed flag that is a Boolean value with 1 representing yes and 0 representing no; a calendar interface table comprising data relevant to general interface items on the calendar, such as day, week, month, year and sorting; a claim number; a last name; and a first name.

The reporting module comprises all the data related to generating report documents that will be exported from the system and for automatically creating a plan of action.

There is also provided a computer-implemented method of a uniform workers' compensation cost containment system for creating a strategic plan for resolving all aspects of a one or more than one claim in an efficient manner and maximizing savings. The method comprises the steps of a) providing the system of claim 1; b) providing instructions stored on a storage executable on one or more than one processor having a memory for a uniform workers' compensation cost containment system for creating a strategic plan for resolving all aspects of a one or more than one claim in an efficient manner and maximizing savings; c) receiving a referral for a claim from a client; d) identifying all areas of workers' compensation that the referral applies too; e) evaluating the claim, where the evaluation comprises instructions executable on a processor for: 1) generating a plan of action, lien analysis or both a plan of action and a lien analysis; 2) generating a provider compliance unit (PCU)/special investigation unit analysis; 3) generating a Lien Type analysis; and 4) generating a bill log; e) automatically reviewing all claims for an explanation of benefits; f) outputting a plan to negotiating settlements to resolve all bills, whether a lien has been filed or not; g) presenting to the client an ongoing management of claims using a computerized user interface dashboard, where the dashboard presents one or more than one report reflecting all providers for one or more than one claim through resolution of the one or more than one claim; h) monitoring, tracking or both monitoring and tracking a Workers' Compensation Appeals Board calendar for hearings dates for each claim and automatically identify one or more than one representative that can attend; and i) identifying, sorting or both identifying and sorting the one or more than one claim by criteria. The criteria comprise: a provider; a lien type; a lien defense; a special investigation unit investigative tool; a settled/not-settled status; and a provider with same tax id numbers, to help improve efficiencies and monitoring. The method also has the steps of representing a client at a Workers' Compensation Appeals Board during a hearing or a conference as a hearing representative to settle, litigate or negotiate liens and representing the client at a Workers' Compensation Appeals Board during a hearing or trial as an expert witness to move forward in trial setting.

There is also provided another method for a uniform workers' compensation cost containment system for creating a strategic plan for resolving all aspects of a one or more than one claim in an efficient manner and maximizing savings. The method comprises the steps of: a) receiving a referral, a collection of bills or an entire claim for bill review, resolution or both bill review and resolution of all outstanding bills related to a specific insurance claim; b) analyzing the referral using an intake module to determine the service requested, documents provided, identify additional documents required, process required documents, and to create a bill log; c) reviewing all relevant bills to input into the system; d) executing instructions to review all bills in detail, including analysis of any related reports to determine proper official medical fee schedule; e) performing a detailed analysis of all file documentation, developing a detailed plan of action, initiating resolutions of bills/liens with a provider, a collection agency or both a provider and a collection agency; scheduling personnel to attend the conference on behalf of a client to present arguments to a judge if required, and negotiate settlement of bill/lien in effort to fully resolve claim; and automatically processing all invoices on a monthly basis, when a claim is closed or both a monthly basis and when a claim is closed. The method further comprises the steps of providing information for an initial WCAB hearing to present information to WCAB judge and automatically scheduling an expert witness to attend WCAB trial.

### BRIEF DESCRIPTION OF THE DRAWINGS

These and other features, aspects and advantages of the present invention will become better understood with regard to the following description, appended claims, and accompanying figures where:

FIG. 1 is a flowchart diagram of some steps of a method for a uniform workers' compensation cost containment system for creating a strategic plan for resolving all aspects of a one or more than one claim in an efficient manner and maximizing savings, according to one embodiment;

FIG. 2 is a workflow diagram of some steps of a method for a uniform workers' compensation cost containment system for creating a strategic plan for resolving all aspects of a one or more than one claim in an efficient manner and maximizing savings, according to one embodiment;

FIG. 3 is a flowchart diagram of a computer implemented system for a uniform workers' compensation cost containment system for creating a strategic plan for resolving all aspects of a one or more than one claim in an efficient manner and maximizing savings, according to one embodiment;

FIG. 4 is a screenshot of a dashboard home module for the system of FIG. 3;

FIG. 5 is a screenshot of a dashboard tasks module for the system of FIG. 3;

FIG. 6 is a screenshot of a dashboard referral/intake/data entry/bill review queue module for the system of FIG. 3;

FIG. 7 is a screenshot of a dashboard dispute resolution queue module for the system of FIG. 3;

FIG. 8 is a screenshot of a dashboard expert witness queue for the system of FIG. 3;

FIG. 9 is a screenshot of a dashboard accounting review queue for the system of FIG. 3;

FIG. 10 is a screenshot of a completed dispute resolution list for the system of FIG. 3;

FIG. 11 is a screenshot of a comprehensive hearing schedule for the system of FIG. 3;

FIG. 12 is a screenshot of a detailed claim showing a bills screen selection for the system of FIG. 3;

FIG. 13 is a screenshot of a detailed hearing calendar selection for the detailed claim of FIG. 12;

FIG. 14 is a screenshot of a claim status selection for the detailed claim of FIG. 12;

FIG. 15 is a screenshot of a claims note selection for the detailed claim of FIG. 12;

FIG. 16 is a screenshot of a documents selection for the detailed claim of FIG. 12;

FIG. 17 is a screenshot of a case facts selection for the detailed claim of FIG. 12;

FIG. 18 is a screenshot of a hearing appearance calendar for the system of FIG. 3;

FIG. 19 is a screenshot of a report generation module for the system of FIG. 3;
and

FIG. 20 is a screenshot of a time and expense accounting module for the system of claim 3.

### DETAILED DESCRIPTION

The present invention overcomes the limitations of the prior art by providing a uniform workers' compensation cost containment system for creating a strategic plan for resolving all aspects of a one or more than one claim in an efficient manner and maximizing savings.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. The flowcharts and block diagrams in the figures can illustrate the architecture, functionality, and operation of possible implementations of systems, methods and computer programs according to various embodiments disclosed. In this regard, each block in the flowchart or block diagrams can represent a module, segment, or portion of code, that can comprise one or more executable instructions for implementing the specified logical function(s). It should also be noted that, in some alternative implementations, the functions noted in the blocks may occur out of the order noted in the figures. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function. Additionally, each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Moreover, a storage may represent one or more devices for storing data, including read-only memory (ROM), random access memory (RAM), magnetic disk storage mediums, optical storage mediums, flash memory devices and/or other non-transitory machine readable mediums for storing information. The term “machine readable medium” includes, but is not limited to portable or fixed storage devices, optical storage devices, wireless channels and various other non-transitory mediums capable of storing, comprising, containing, executing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc. and are also referred to as an interface, where the interface is the point of interaction with software, or computer hardware, or with peripheral devices.

In the following description, certain terminology is used to describe certain features of one or more embodiments of the invention.

The term “claim” refers to any bill or lien perfected into a lien that is charged under an insurance claim.

The term “lien” refers to a bill where a provider has perfected and paid its' lien filing fee dues.

The term “bill” refers to both medical and non-medical services charged under an insurance claim.

The term “partnership” refers to an arrangement where parties agree to cooperate to advance mutual interest.

Various embodiments provide a uniform workers' compensation cost containment system for creating a strategic plan for resolving all aspects of a one or more than one claim in an efficient manner and maximizing savings. One embodiment of the present invention provides a uniform workers' compensation cost containment system for creating a strategic plan for resolving all aspects of a one or more than one claim in an efficient manner and maximizing savings. In another embodiment, there is provided a method for using the system. The system and method will now be disclosed in detail.

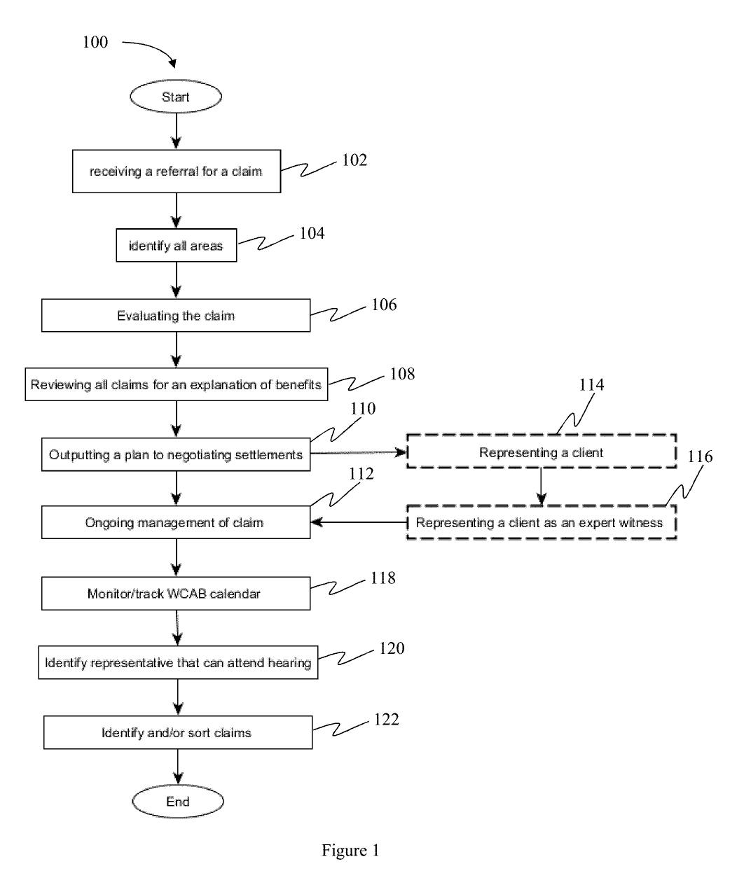

Referring now to FIG. 1, there is shown a flowchart diagram 100 of some steps of a method for a uniform workers' compensation cost containment system for creating a strategic plan for resolving all aspects of a one or more than one claim in an efficient manner and maximizing savings. The method comprises the steps of first providing instructions executable on a processor having a memory for a uniform workers' compensation cost containment system for creating a strategic plan for resolving all aspects of a one or more than one claim in an efficient manner and maximizing savings. Then, receiving a referral for a claim 102 by the system. Next, identifying all areas 104 of workers' compensation that the referral applies too. Then, evaluating the claim 106, where the evaluation comprises instructions executable on a processor for: 1) generating a plan of action (POA), lien analysis or both a plan of action and a lien analysis; 2) provider compliance unit (PCU)/special investigation unit (SIU) analysis; 3) Lien Type analysis; and 4) generating a bill log. Next, automatically reviewing all claims for an explanation of benefits 108. Then, outputting a plan 110 to negotiating settlements to resolve all bills, whether a lien has been filed or not. Next, optionally representing a client 114 at a Workers' Compensation Appeals Board (WCAB) during a hearing or a conference as a hearing representative to settle, litigate or negotiate liens. Then, optionally representing the client at WCAB during a hearing or trial as an expert witness 116 in partnership with counsel or client representative to move forward in trial setting. Next, presenting to the client an ongoing management of claims 112 using a user interface dashboard, where the dashboard presents one or more than one report reflecting all providers for one or more than one claim through resolution of the one or more than one claim. Then, monitor, track or both monitor and track 118 a WCAB calendar for hearings dates for each claim and identify one or more than one representative that can attend. Next, if representing the client 114, identify a representative 120 that can attend the hearing. Finally, identify, sort or both identify and sort the one or more than one claim 122 by:

provider;

lien type;

lien defense;

SIU (investigative tool);

settled/not-settled status; and

Provider with same tax id numbers,

to help improve efficiencies and monitoring.

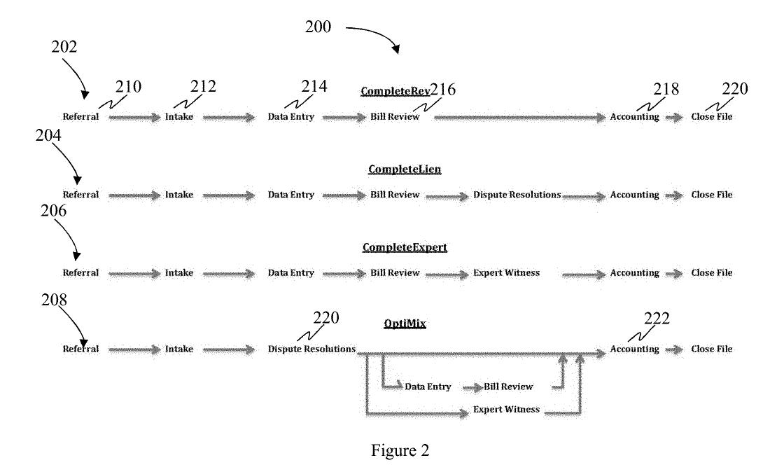

Referring now to FIG. 2, there is shown a detailed workflow diagram 200 of some steps of a method for a uniform workers' compensation cost containment system. As can be seen, there are several modules 202, 204, 206, and 208 that can be used to implement the method for a uniform workers' compensation cost containment system. In the modules 202, 204, 206, and 208, several common aspects are implemented. A referral 210 is a bill, a collection of bills or an entire claim that is referred for bill review or resolution of all outstanding bills related to a specific insurance claim. An intake module 212 is used for initial analysis of the referral 210 to determine the service requested, documents provided, identify additional documents required, process required documents, such as, for example, an SOA, an NOA, etc, and to create a bill log. A data entry module 214 is used to review all relevant bills to input into the bill review software. A bill review module 216 executes instructions to review all bills in detail, including analysis of any related reports to determine proper official medical fee schedule. A dispute resolutions module 220 performs a detail analysis of all file documentation, develops a detailed plan of action (POA), initiates resolutions of bill/lien with a provider or a collection agency. If required, the dispute resolution module 200 comprises information for an initial WCAB hearing (conference) to present information to WCAB judge. The dispute resolution module 200 can schedule personnel to attend the conference on behalf of a client to present arguments to a judge if required, and negotiate settlement of bill/lien in effort to fully resolve claim. Additionally, the dispute resolution module 200 can schedule an expert witness to attend WCAB trial or as an expert witness to work with the client's attorney or client's representative to settle all liens set for trial, and presented in front a WCAB judge. An accounting module 222 is used to process all invoices on a monthly basis or when a claim is closed.

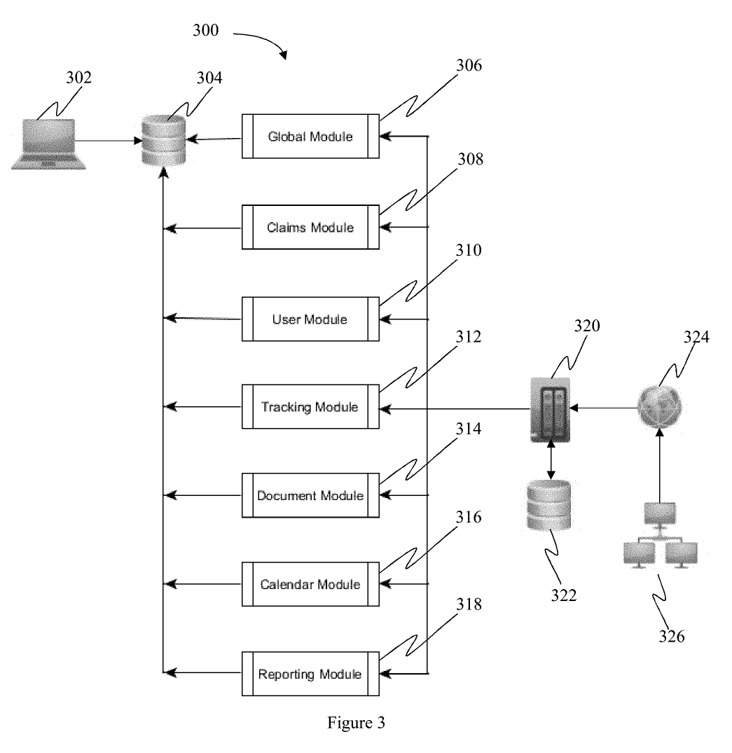

Referring now to FIG. 3, there is shown a flowchart diagram of a computer implemented system 300 for a uniform workers' compensation cost containment system for creating a strategic plan for resolving all aspects of a one or more than one claim in an efficient manner and maximizing savings, according to one embodiment. As can be seen a processor 320 comprising instructions and data for various modules 302, 304, 306, 308, 310, 312, 314, 316, and 318 can be accessed by internal users 302 and over the internet or a private network 324 by external users 326. The processor 320 is operably connected to a storage 322 that comprises all the information and executable instructions necessary for the system 300 to produce uniform workers' compensation cost containment strategic plans for resolving all aspects of a one or more than one claim in an efficient manner and maximizing savings. External users 326 can access the system 300 using custom dashboards via a web browser that serve limited data based on their respective activities and permissions or full access permission.

The processor 320 interacts with data stored in the storage 322 using several modules that comprise instructions executable on the processor 320. A basic set of modules that the processor 320 requires to operate the system are a global module 306, a claims module 308, a user module 310, a tracking module 312, a document module 314, a calendar module 316 and a reporting module 318. All of the modules 302-318 are communicatively coupled to the processor 320 and the storage 322.

The global module 306 comprises instructions to access the storage 322 by users in one primary office location, as well as staff remote access. It also tracks and authenticates users, groups, and administrators. There are various levels of access that the global module 306 comprises, such as for example, a superuser has read and write access to all information in the storage 322, but no access to storage 322 architecture, scripting or editing of layouts. A manager has read and write access all tables except staff table where user accounts are created and managed, but no access to storage 322 architecture, scripting or editing of layouts. A staff member has read and write access to all table except staff. The staff group will not have access to management dashboard and no access to storage 322 architecture, scripting or editing of layouts. A general access has read only access to all tables except staff, plus create/edit for comments.

The global module 306 also comprises the following capabilities: data migration of existing bill log data that is contained in spreadsheets to be imported into the system. Layout design specifications for the client to select required or preferred colors/color schemes and screen resolution(s) during development of their storage 322. Global navigation of the dashboard in the form of a header with global navigation will be present on every layout, except reports. Local navigation is provided as a sidebar showing other table records will be present on form view detail layouts for quick access to other records in the same table. All tables in the storage 322 require certain fields for internal tracking and building relationships to other tables, including: A primary key: used to create parent/child relationship with other tables; foreign keys: used to create child/parent relationship with current table; a creation timestamp to record when each record was created in the system; a created by field comprises a user account name of record creator; a modified by field comprises a user account name of last user to modify the record; a modification timestamp field, to record a timestamp of the last activity on record; a message board table field comprises all the data relevant to messages on the message board, with one record per message, including: a message field will contain text that will be displayed.

The claims module 308 comprises tables stored in the storage 322 to manage the core data needed to track and manage clients, contacts, liens and claims; including the providers and staff they are associated with. The claims module 308 is the core of the system 300 because it holds all of the pertinent information related to the core business activities of the client. A claims table comprises data relevant a specific claim file, claimant and involved parties, with one record per claim, including: carrier third party administrator (TPA); first name; middle initial; last name; suffix; full name: concatenated first name and last name; social security number; date of birth; employer; claim number; adjustment number; settlement date; date of injury; injury type; court start date; hearing at referral; claim status; claim status date; defense firm; defense attorney; WCAB; broker name; broker company; employer subsidiary; carrier TPA office; CFCREP: staff assigned to own the file; claim referral date: date referral received by an office; days in portfolio: calculation of time the office has had file since referral; claim referred by; claim phase; remaining liens: count of related records from liens table that are still open; plan of action (POA); claim adjuster; product: the office internal product assigned to file; companion claims; claim status: assigned based on stage of file in the office standard operating procedure (SOP); intake complete date: auto-entered when intake advances claim next department; referral complete date: auto-entered when referral advances claim to intake; first request: timestamp of first document request; second request: timestamp of second document request; request to; and document notes.

The claims module 308 also comprises layouts for the data. The layouts comprise a claims list view of all claim records in the system. A claims table that comprises developer layout that will have all claims fields. The layout will be referenced by scripts that interact with the claims table. Claims detail contain a form view layout that shows the claim detail and related information, currently known as “lien manager” and illustrated in the wireframes. This layout will be used by dispute resolution representatives when viewing claims they are assigned to. An intake form view layout that shows fields needed for intake reps to process the file, currently known as “intake manager”. This layout is where new liens are added, as well as referral documents. A referral form view layout that shows fields needed for referrals reps to create and enter the claim information. Referral documents, companion claims, claim notes and hearing calendar information are entered on this layout.

The claims module 308 also comprises functional instructions to: add a new claim by creation of new claim record. Upload claim documents. A view claim document: opens a popover that shows a larger view of the document that uses interactive container so user can scroll/navigate multipage documents; delete document: removes document from container field. Delete claim and related data: should a claim record need to be deleted, it will be a scripted event that removes all related table data. If a staff member deletes a record, it will be flagged for deletion for the system admin to review. Import liens. Advance to next department: sets the status of the claim to the next department and adds this record to their queue for processing. Liens portal: shows related lien records. Claim notes portal: shows related claim notes records. Companion claims portal: shows related companion claim records. Select services: users choose from value list of available services for this claim. A call log portal: shows related call log records. Generate plan of action. Bill log portal: shows related bill log records. Assign status to claim. Claim notes table: this table comprises data relevant to a claim note, with one record per note, including: date: auto-enter date stamp; note text; user: auto-enter based on user account name; note type; layouts; claim notes table: developer layout that will have all claim notes fields. This layout will be referenced by scripts that interact with the claims notes table.

All creation of claim notes records will be scripted through this layout and comprise the following functionality: add claim notes: scripted creation of new claim notes, recorded and populated with foreign keys of related parent tables. This function will always be initiated from the parent table. Liens table: this table comprises data relevant to a specific lien, related to a claim and client, with one record per lien, including: provider; electronic adjudication management system (EAMS); lien amount; official medical fee schedule (OMFS); settlement amount; settlement date; settlement method; notice of intent (NOI) date; NOI; remaining liens counter; total billed; total paid; settlement on dollar; total liens; lien amount status; OMFS status; EAMS status; service provided; settled by; lien amount status date; OMFS status date; EAMS status date; the office recommended amount; amount paid; billed amount; location settled: in-house or in-court. The functionality described above will have the following layouts: a lien list: list view of all liens in the system. A lien table: developer layout that will have all liens fields. This layout will be referenced by scripts that interact with the claims table. The following functions will be available in these layouts: add new lien: scripted creation of new lien record and populated with foreign keys of related parent tables. This function will always be initiated from the parent table. A lien notes table: this table comprises data relevant to a lien note, with one record per note, including: a date: auto-enter date stamp; note text; user: auto-enter based on user account name; note type. A lien notes table: developer layout that will have all lien notes fields. This layout will be referenced by scripts that interact with the lien notes table. All creation of lien notes records will be scripted through this layout. Add lien notes: scripted creation of new lien notes recorded and populated with foreign keys of related parent tables. This function will always be initiated from the parent table. Clients table: this table comprises data relevant to a specific client, with one record per client, including: client name; client program; address1; address2; city; state; zip; phone; fax; email; client type. A clients table: developer layout that will have all client fields. This layout will be referenced by scripts that interact with the clients table. All creation of client records will be scripted through this layout. A client list view: list view of all client records in the system. This view comprises functionality to: add new client record; add new related claim record; contacts table: this table comprises data relevant to a specific contact, with one record per client. A contacts table: developer layout that will have all contact fields. This layout will be referenced by scripts that interact with the contact table. All creation of contact records will be scripted through this layout. Contacts list: list view of all contact in the system. This layout will show related provider and provider offices data for each contact record and have the following functions: add new contact: scripted creation of new contact record and populated with foreign keys of related parent tables. This function will always be initiated from the parent table. A providers table: this table comprises data relevant to a specific provider, with one record per provider. A providers table: developer layout that will have all provider fields. This layout will be referenced by scripts that interact with the providers table. All creation of provider records will be scripted through this layout. A provider list: list view of all provider records in the system. A provider detail form view of a single provider record that shows specific record data as well as related provider offices and contacts data.

The tables in the user module 310 comprises all data related to users of the system, custom activities per user and custom dashboard home screens. This module will also hold the scripting to create a user, add security accounts, change passwords and remove users and associated security. All tables: every table requires certain fields for internal tracking and building relationships to other tables. The user module 310 will have the following functionality: Add a new staff record. Assign role to staff member: this determines which dashboard screen the user will land on. Assign privilege set: this controls the level of access the user has to the system. Create password: create password user will use to access the system. Create account: scripted creation of a native security account. The login will be the user's full name. Password field that was set in prior step will be purged for security purposes. Reset password: reset user password in case they forgot it. Recreate account: allows the changing of the user name or to reactivate the user in the system. Used in cases where a staff member is married and has a new last name or if a user leaves and then returns to the company. This scripted event updates the security account with the new full name. Remove user: scripted event that deletes staff record and removes the security account. Notify user of account creation: auto-generated email with login and password. An activities table comprises data relevant to a specific activity assigned to a staff member, with one record per activity.

The tables in the tracking module 312 comprises all the data related phone and time tracking for employees, activities, liens and claims. Every table in the tracking module 312 requires certain fields for internal tracking and building relationships to other tables including: a demand, an offer; and a difference: calculated based on demand offer.

The tables in the document module 314 comprises all the data related documents stored in the system 300 and requires certain fields for internal tracking and building relationships to other tables including: a document class table: this table will be used to generate a custom value list for classifying documents, with one record per document class. A document class table will have all fields. This layout will be referenced by scripts that interact with the related document class table. All creation of records will be scripted through this layout. And a document class list view of records. A document manager table will serve as the home screen for searching and reporting features related to documents stored in the system. Users will have the option of viewing related documents throughout the system, or come to the document manager to search for specific documents.

The tables in the calendar module 316 comprises all the data related to calendar items for appearances including: a code; a litigation calendar table: this table comprises data relevant to specific calendar entries, with one record per calendar entry including: a claim number, a last name, a first name, a judge; assigned representative; total appearances that is a count of appearance records; an outcome; an appearance needed flag that is a Boolean value with 1 representing yes and 0 or null representing no; a calendar interface table: this table comprises data relevant to general interface items on the calendar, such as day, week, month, year and sorting.

The tables in the reporting module 318 comprises all the data related to generating report documents that will be exported from the system. Internal reporting can be done locally for each table, but generated documents will aggregate data across needed tables into a separate report table, so it can be preserved for future reference. The reporting module 318 comprises certain fields for internal tracking and building relationships to other tables, including: a report table: this table will be used to generate reports, including: a report builder table; a reports field for report pre-determined design and formatting to ensure strict legal formats (where required) are used; a quarterly field that will display aggregated data report for the selected quarter. Metrics will include: total claims referred; total providers referred; total providers resolved; total remaining providers; total percentage of providers resolved; total lien amount referred; total lien amount resolved; total lien amount remaining; total settlement amount to resolve; total gross savings in dollars; percentage of savings—resolved inventory; a partnership report will display aggregated data for the selected partnership over the selected quarter. Metrics will include: total inventory; total gross savings; total lien amounts resolved; total percentage of gross savings; providers resolved; percentage of liens resolved; remaining providers; closed files; total invoiced to partner; total net savings; total percentage of net savings; total closed; total lien amounts resolved; total settlement amount; total gross savings; percentage of gross savings; bill log report is generated by the client.

The reporting module 318 also creates a plan of action. All client, claim and lien data will be pulled in from their respective tables that comprises the standard header/footer for all generated documents. Lien claimants will be auto-generated based on liens attached to claim, as well as “resolved before the office referral” section. WCAB hearing data will be pulled in based on related record data for the claim. Internal employees will manually enter “strategy” section into a text field on the POA builder layout, which will also show all the aforementioned data. When the internal employee is finished entering the strategy, he/she will click “generate POA document.” A pdf of the POA will be auto-generated and placed on the employee's desktop. The report record for this POA will remain intact and will be locked from editing once employee marks the POA as “sent.” The employee will have the option of creating additional revisions of POA while retaining historical document data for previously sent POA's. A phone log. Employee billable time will be stored, except some data will be auto-filled based on billable flags on the call log. A custom reports builder and sample reports. A list of all documents in the system 300 that are searchable based on: a claim number; an adjuster number; a client; a partner; a close date; a referral date or a contact.

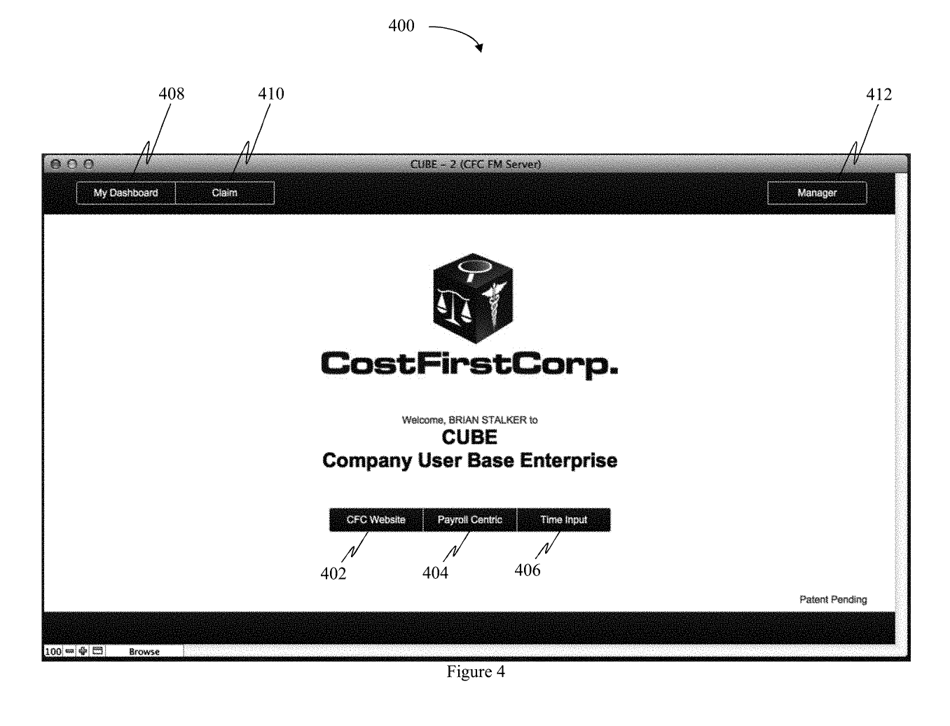

Referring now to FIG. 4, there is shown a screenshot of a computer implemented graphical user interface (GUI) 400 for a uniform workers' compensation cost containment system for creating a strategic plan for resolving all aspects of a one or more than one claim in an efficient manner and maximizing savings. As can be seen, there are several options displayed by the system 300 on the GUI 400 to automate the claims process. The tabs 402, 404, 406, 408, 410 and 412 correspond to specific modules, discussed below, for processing the data and transforming into a strategic plan for the client. The CFC Website tab 402 provides the user with internet access to a remote server where information related to a claim can be stored and access depending on the access level of the user. The Payroll Centric tab 404 executes instructions contained in a module to calculate payroll for employees using the system 300. The time input 406 tab executes instructions so that an employee can track time spending on a particular claim to assist both a payroll centric module 404 module and an accounting module. The “my dashboard” tab 408 will display the user's dashboard and various levels of tasks and documentation that is based on the user's access level. The claim 410 tab will execute the claims module 308 and begin or continue the claims process for a matter. The manager 412 tab, executes specific instructions in the global module 306 at an elevated access level. Typically, the manager tab 412

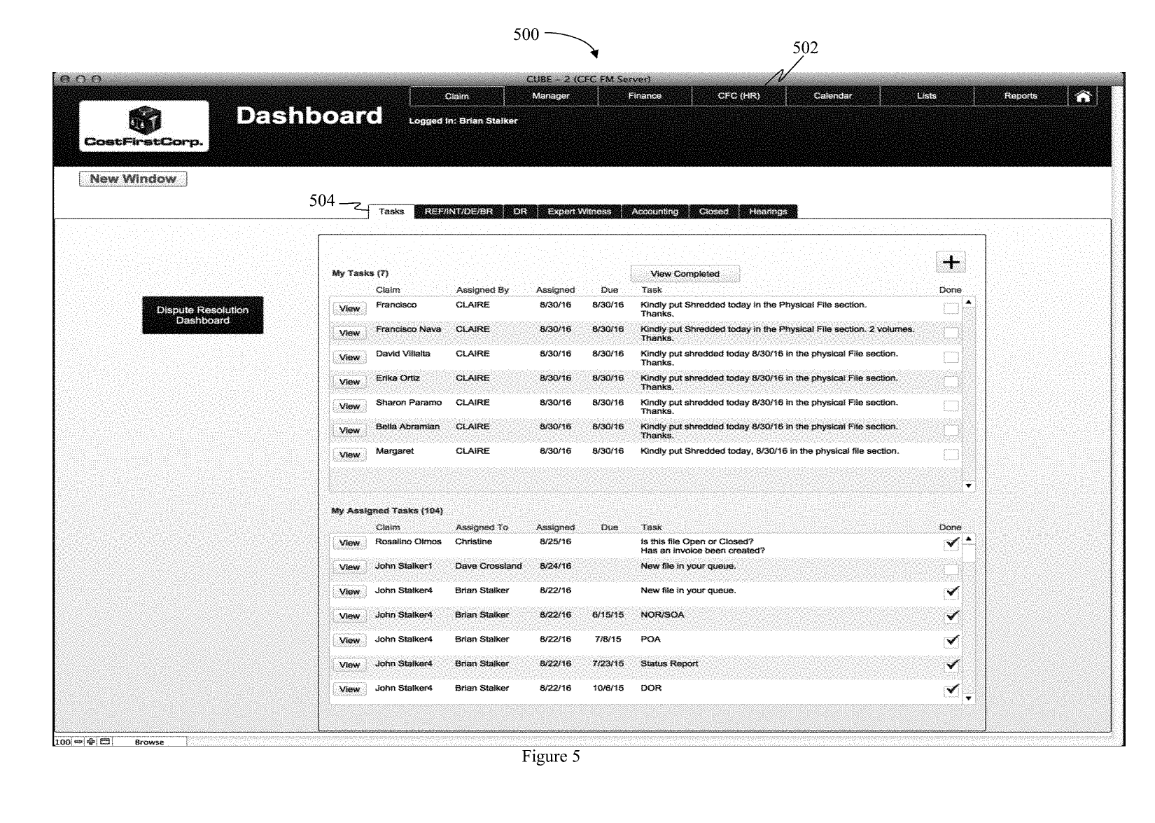

Referring now to FIG. 5, there is shown a screenshot 500 of a dashboard module 502 for the system 300. The top dashboard tabs 502 display various modules that can be accessed depending upon permissions granted to a user. For example, a tasks tab 504 is displayed to remind an employee of processing that still needs to be completed or data that needs to be entered or reviewed. To accomplish this, there are executable instructions in the system 300 for the one or more than one processor to display tabs 504 corresponding to various modules and executable instructions for completing a claim or a dispute resolution. The lower dashboard tabs 504 linked to the various executable modules in this example comprise a tasks tab 502, a referral/intake/data entry/bill review tab 602, a dispute resolution tab 702, an expert witness tab 802, an accounting tab 902, a closed tab 1002 and a hearing tab 1102. The functionality of each of these tabs 502 is discussed below. The tasks tab displays a list of tasks to be completed by the employee and also provides a “Done” column to indicate tasks that have been completed. Additionally, once a task is “Done”, the system can automatically change the color of the task and limit access to the task using the “view” button. When enabled, the “view” button opens a defined task including claim number, requested by, due date and notes detailing the tasks. It also opens all the documents and related material to that particular task for review by the employee.

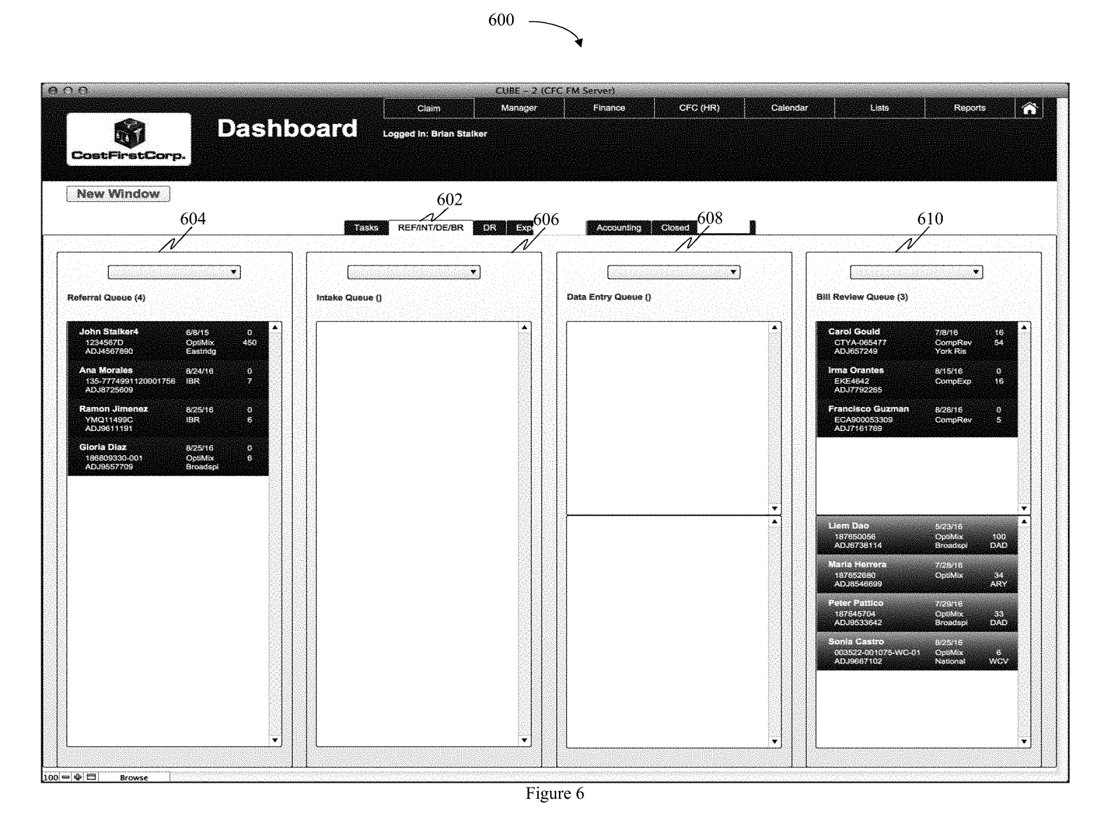

Referring now to FIG. 6, there is shown a screenshot of a referral module 600 for the system 300. As can be seen the referral tab 602 displays all the related information needed to perform the referral/intake/data entry/bill review functions for the system 300. Depending on the client's instructions, the referral process can be automated using a series of codes, or can be semi-automated with some guidance to the system 300 input by the employee. The information related to the referral is automatically collected and collated by the system 300 once the initial claim information has been input into the system 300. Normally, a referral is requested electronically and the system 300 automatically populates and distributes tasks to available employees where needed or processes the claims automatically when possible. However, a few claims need to be input into the system 300 by manual data entry.

Once the claims have been input into the system 300 the information and data related to the referral is input into one of four columns in this example. A referral queue 604 shows referrals waiting for processing, an intake queue 606 displays claims awaiting intake into the system 300, a data entry queue 608 displays any claims that need to be manually input into the system 300 and a bill review queue 610 displays claims that are ready for review by the system 300.

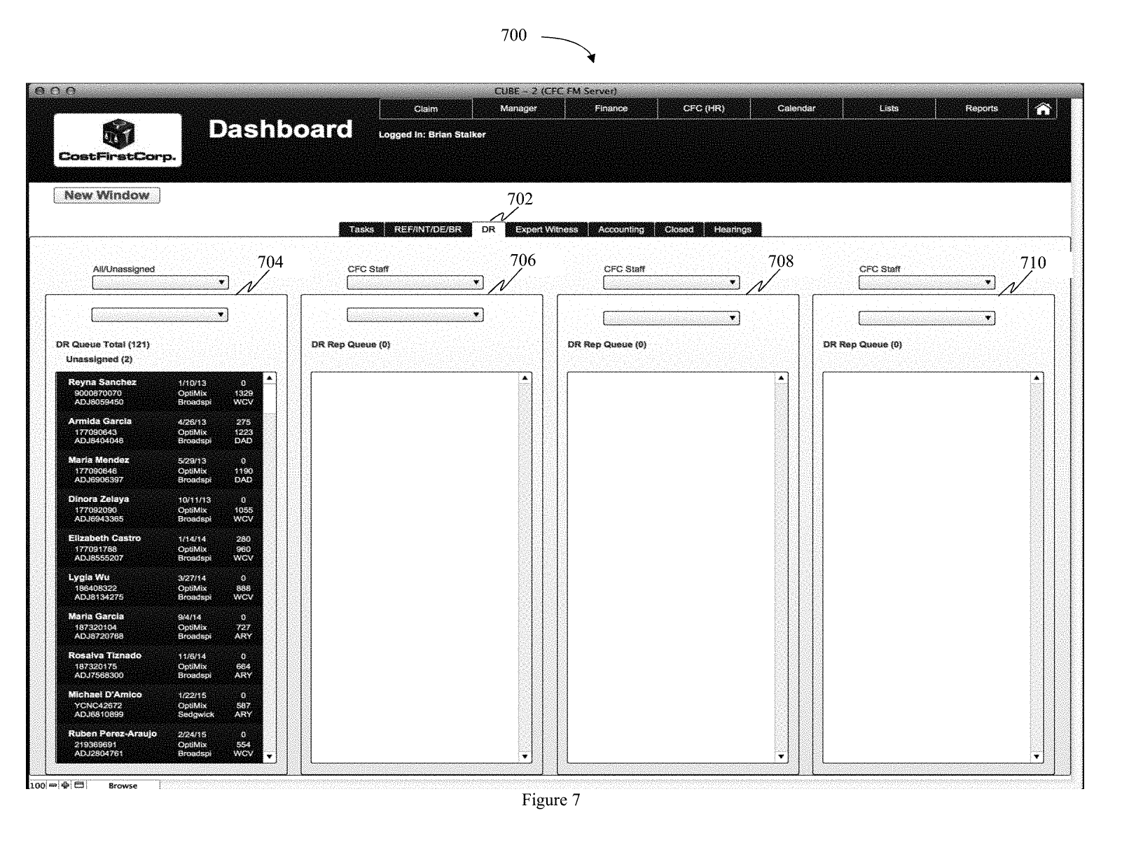

Referring now to FIG. 7, there is shown a screenshot of a dispute resolution intake module 700 for the system 300. The data displayed here is automatically received by the system from a variety of sources, such as, for example the processor 320. Once the data has been retrieved from all the various sources, the system automatically matches the data with the correct matter and updates the storage 322 with the most current information. In current processing schemes, this is a completely manual process that can lead to delays, inefficiencies and inaccuracies that can affect the client. The system 300 displays a dispute resolution intake screen 702 that shows the available data on the claim/lien matter. There are four columns 704, 706, 708, and 710 displayed by the system 300. A total queue 704 displays a list of unassigned matters. The remaining three staff assignment columns 706, 708, and 710 are available to display the current dispute resolution cases assigned to a selectable staff member. By selecting different staff members in each of the staff assignment columns 706, 708, and 710, a manager can view the amount of cases assigned to various staff members. This way, the system 300 provides a mechanism so that claim matters can be manually assigned to a particular staff member with a user with the proper access level or administrative privileges.

The dispute resolution module 700 can also display a log of all claims for a particular person, client, proceeding or any other related information so that the client has a complete and succinct log of the matter. As can be seen the diary can provide specific details, including a history, of each provider for the specific matter. This provides more flexibility than is possible with current systems that can only track one matter at a time and don't correlate all the available information in one location. This function can save the client a great deal of time and money, and help process claims faster. If a specific provider is pulled from the lien/bill log it is referred to as a diary. It notes specific details of each provider on the lien/bill log. The diary can pull all notes and history taken during the course of life of the claim.

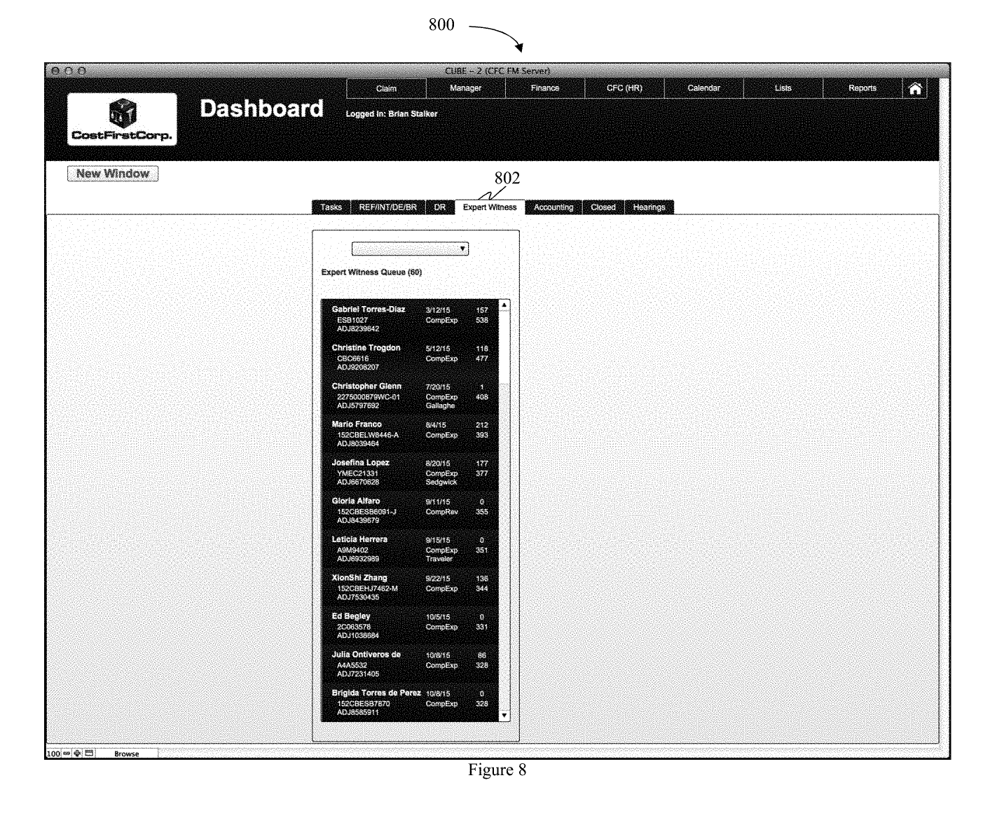

Referring now to FIG. 8, there is shown a screenshot of available expert witnesses module 800 for the system 300. The system 300 displays formatted entries for data that the employee needs to enter during the semi-automated processing of the claim. Only the information needed can be entered. All other information can be reviewed, but not altered by the employee.

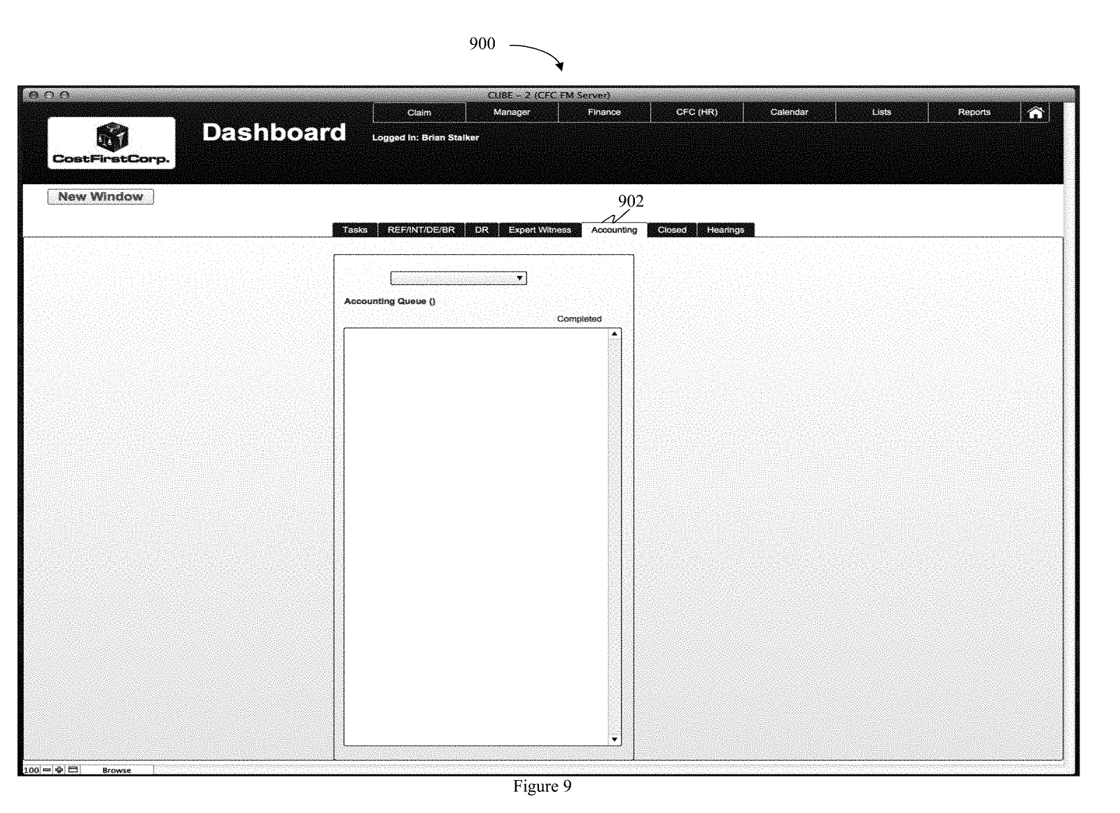

Referring now to FIG. 9, there is shown a screenshot 900 of an accounting review module 902 for the system 300. The system 300 automatically flags claims that need to be reviewed by the employee for accounting reasons. All the necessary case details are also displayed when selected from the drop down list box, so that the corrected documents can be manually confirmed by the employee.

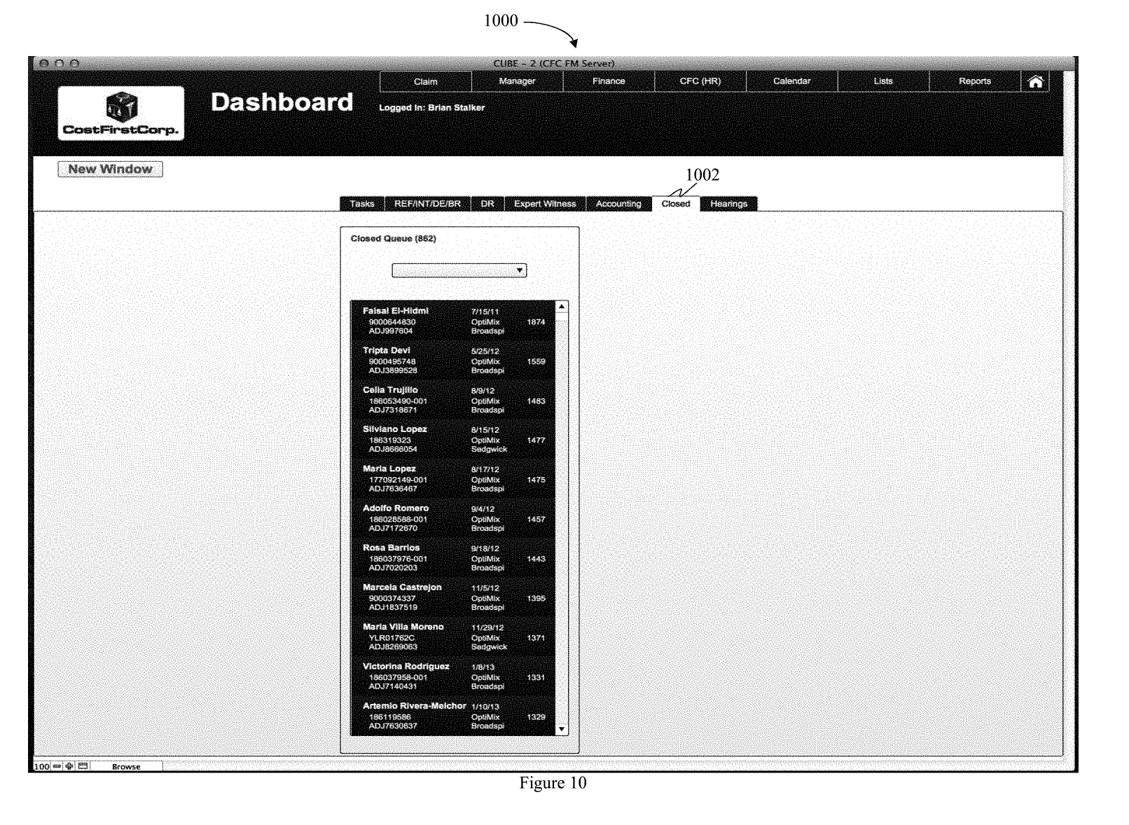

Referring now to FIG. 10, there is shown a screenshot of completed dispute resolution list module 1000. The system 300 displays a list of completed or closed claim matters for historical review and accounting purposes. If a legal appeal or other action occurs with a particular claim, all the documentation related to that matter can be retrieved and sent to the appropriate module in the system 300 for processing.

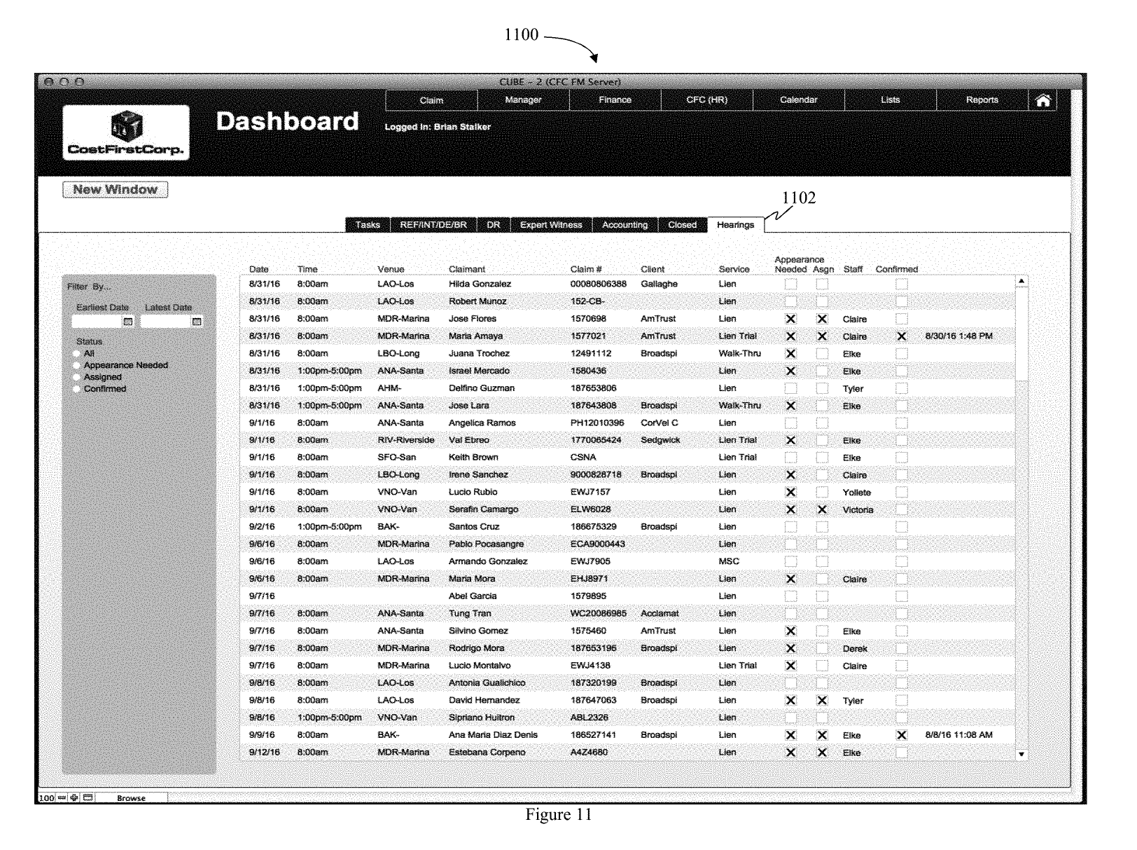

Referring now to FIG. 11, there is shown a screenshot of comprehensive hearing schedule module 1100 for the system 300. The hearing schedule module 1100 tracks all the hearing appearances and schedules. As is the case with many administrative legal processes, the dates and times can change. The system 300 retrieves updates from the WCAB and other agencies and identifies conflicts with the current schedule. Assigned staff can be automatically or manually adjusted by the system 300 and the hearing schedule module 1100 to avoid conflicts.

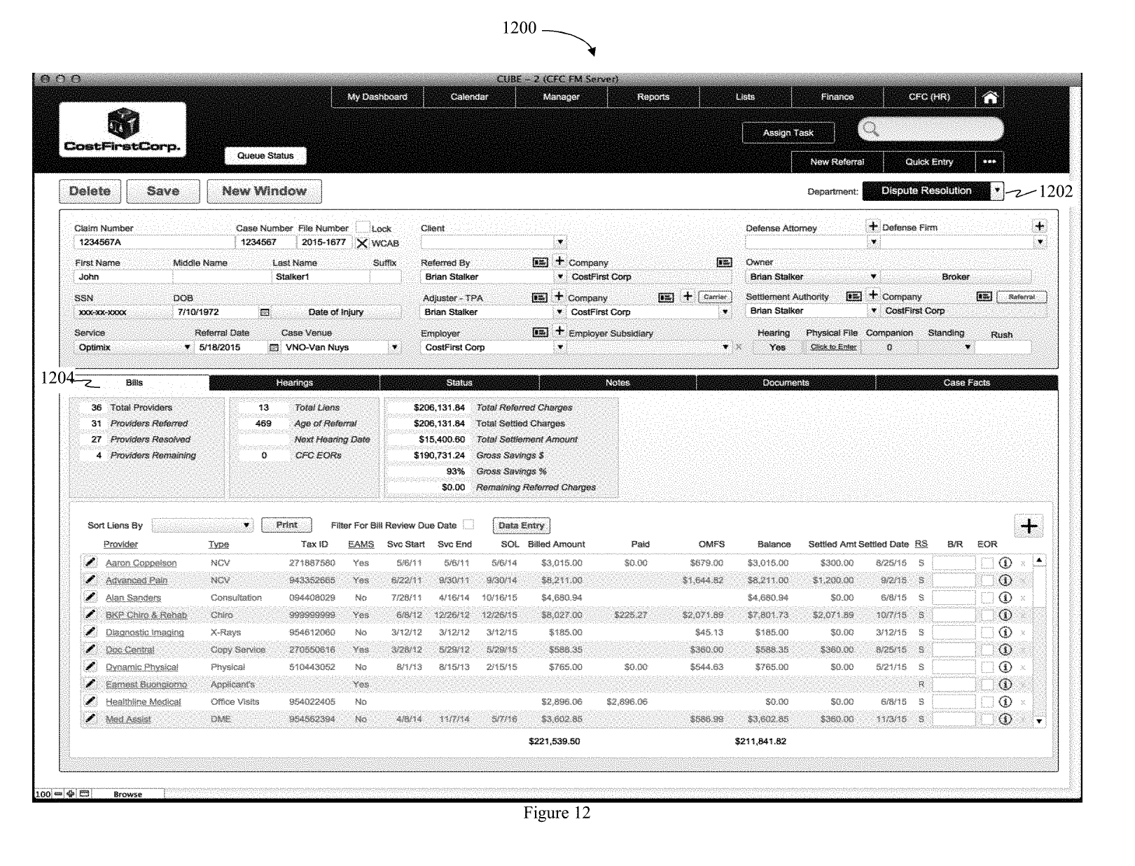

Referring now to FIG. 12, there is shown a screenshot of a detailed claim module 1200 showing a billing screen selection. As can be seen, the claim module 1200 comprises many sections and can display a variety of information related to a claim, lien or matter. Once the user has selected a department 1202 and entered a claim to view the data related to that matter number is populated and displayed. The available data is broken into tabbed sections 1204 for easier and more logical handling of the data than paper files of the prior art. A bills tab 1204, hearings tab, a status tab, a notes tab, a documents tab and a case facts tab are also available to the user. In this example, the tabbed section displayed is the bills tab 1204.

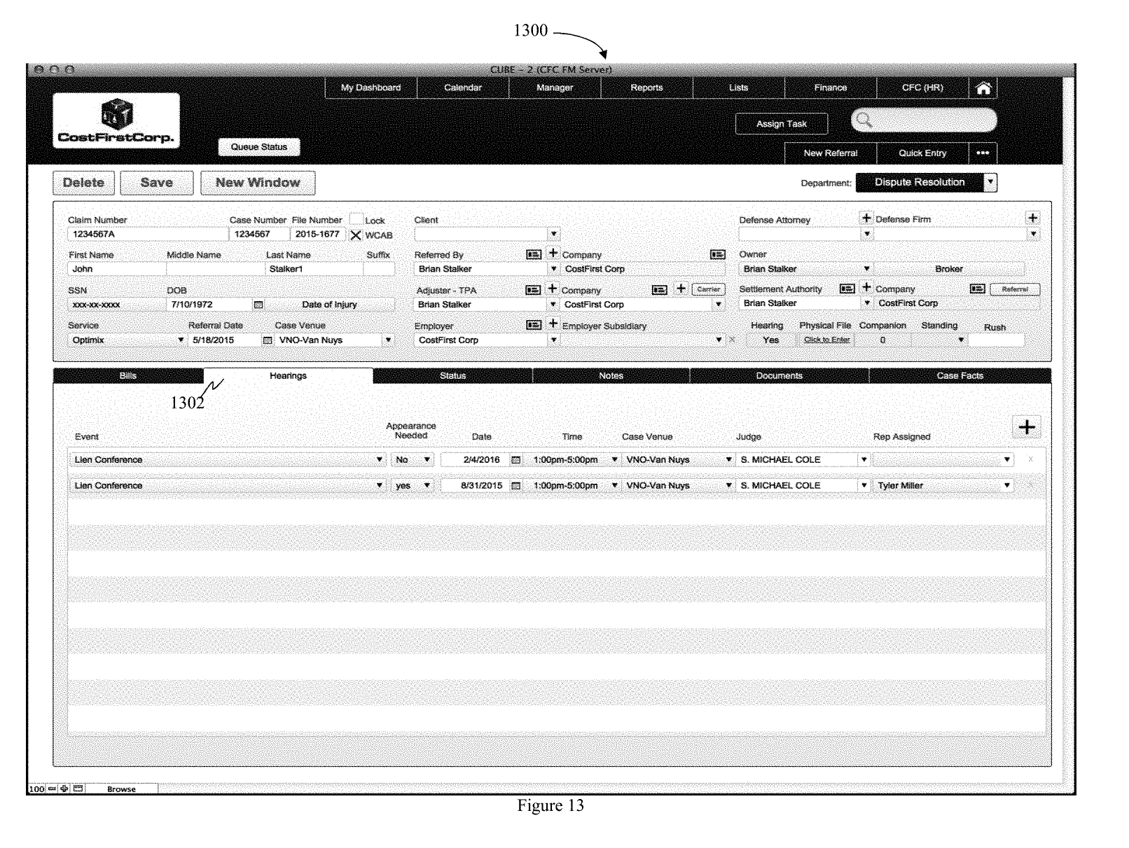

Referring now to FIG. 13, there is shown a screenshot of a detailed hearing calendar selection module 1300 for the detailed claim 1100. As can be seen, the system 300 also can automatically retrieve court dates for matters before the WCAB to assist in the preparations for the client's attorney(s), the expert and all others that will be needed during the proceeding. The hearing calendar 1302 displays a quick snapshot of who, what and when regarding the documentation and attendance that will be needed for a scheduled hearing. The system 300 is designed so that a calendar clerk can manually override the system and assign a case hearing to a hearing representative or an expert witness depending upon the request of the client.

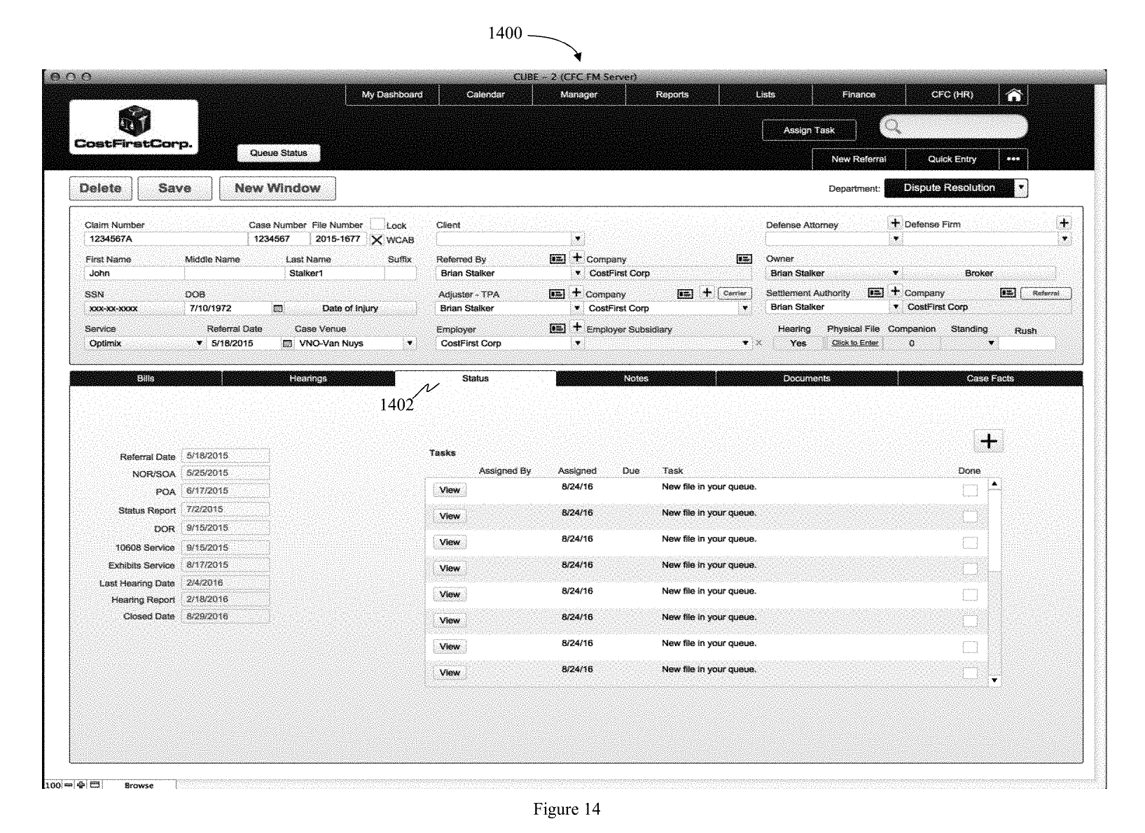

Referring now to FIG. 14, there is shown a screenshot of a claim status selection module 1400 for the detailed claim 1100. The system 300 comprises different comprehensive diaries for the various modules 302, 304, 306, 308, 310, 312, 314, 316, and 318 of the system 300. In this example, there is shown a status 1402 list. This is a comprehensive list of the status of all the claims that are currently being processed by a user in the system 300. Unlike current systems, this module alone can save vast amounts of time and effort in processing workman's compensation claims. All the pertinent status information is displayed and can be easily accessed by the user. Prior art methods require the user to sift through files and disparate records in various locations and attempt to make sense of how best to reduce the costs associated with a claim. Using the present invention, cost savings and “what if” scenarios can be accomplished almost immediately and the system 300 is configured to produce the most favorable results based on the data provided by the claim/lien holder. This automated methodology provides vast improvements over the prior art.

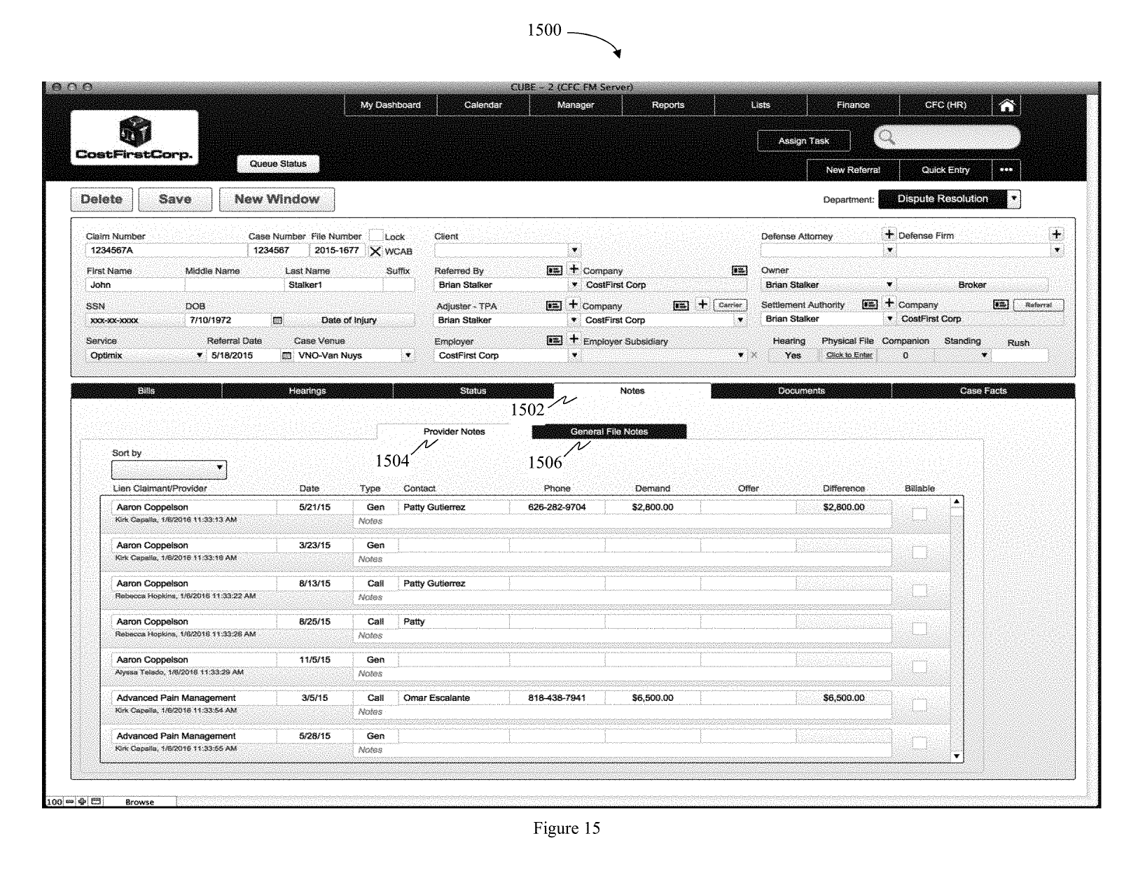

Referring now to FIG. 15, there is shown a screenshot of a claims note selection module 1500 for the detailed claim 1100. In this section the notes tab 1502 comprises at least two other tabs: a provider notes tab 1504 and a general file notes tab 1506. This provides the user with instant access to all the information entered into the system 300 by a remote provider and local notes added by staff. The history of the matter can be sorted by a date, a party name, a claimant, or any other field displayed by the system 300. As will be understood by those with skill in the art with reference to this disclosure, there are many other fields that can be displayed. The present example is not meant to limit other possibilities within the scope of the claimed invention.

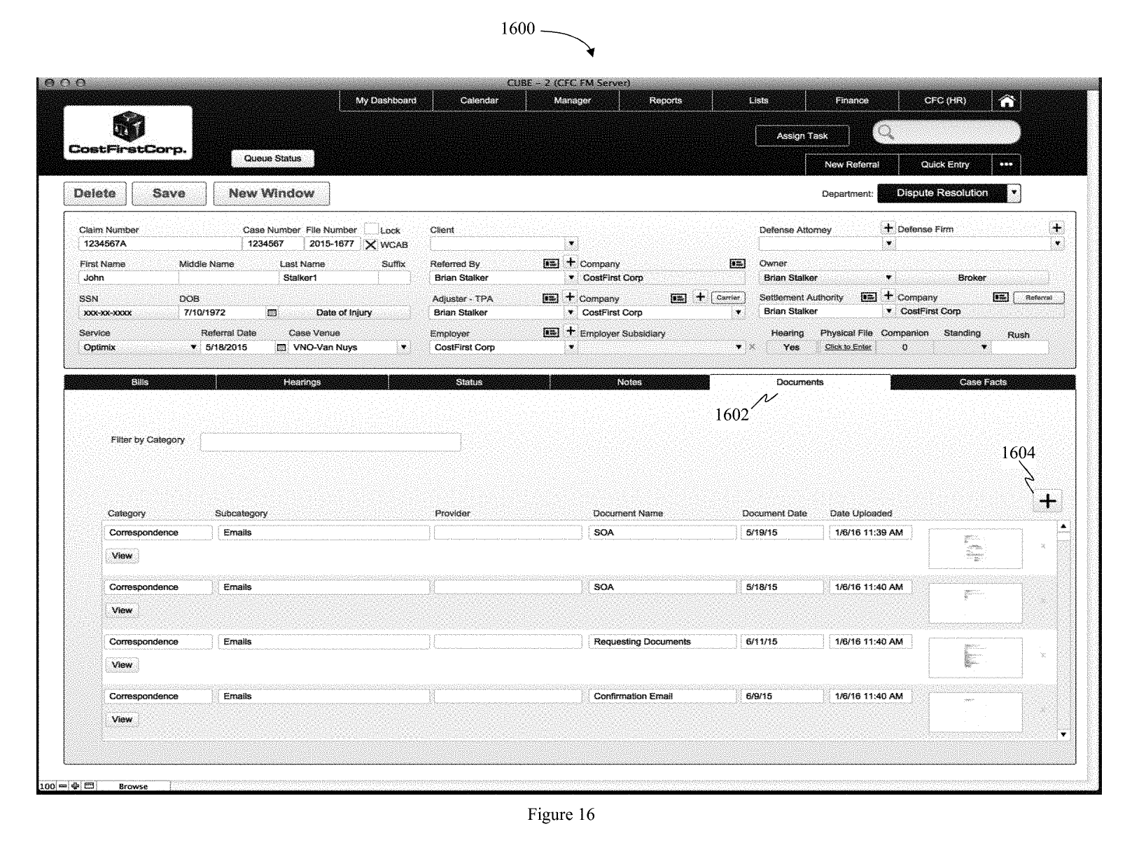

Referring now to FIG. 16, there is shown a screenshot of a documents selection module 1600 for the detailed claim 1100. The user can select the documents tab 1602 to access all the documents attached to the matter. The user can also add documents to the matter by selecting the “+” icon 1604 and entering or uploading the document with all the appropriate information for the system 300 to maintain the documents relationship with one or more than one claim/lien or matter.

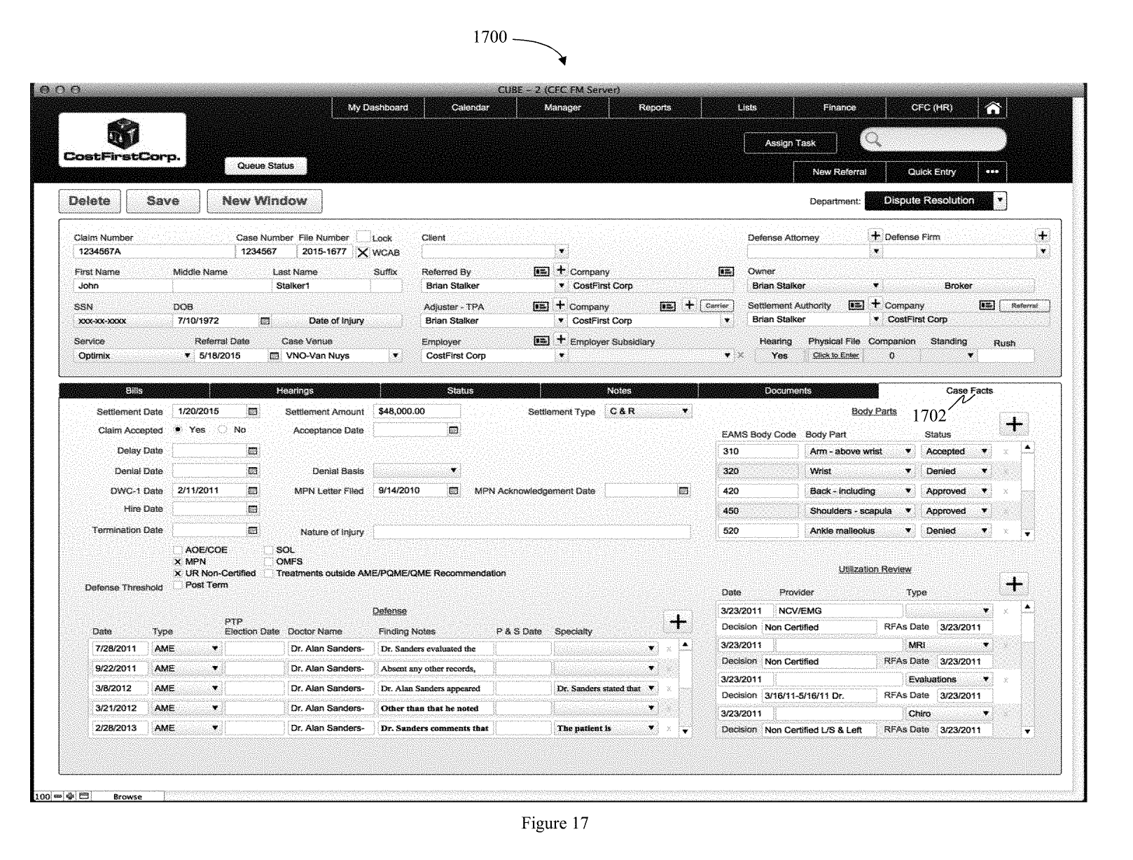

Referring now to FIG. 17, there is shown a screenshot 1700 of a case facts module 1700 for the detailed claim 1100. The case facts module 1700 displays all the known facts in the matter. This is important to consolidate all the facts in one location so that any expert, either an in-house representative, an expert witness or a third party expert has access to the case facts prior to attending a hearing or beginning a negotiation. Additionally, documents can easily be compared and located automatically by the system 300 to make preparation for an appearance easier. Reports and documents for the hearing can also be constructed based off of the case facts stored in the system 300 and displayed here.

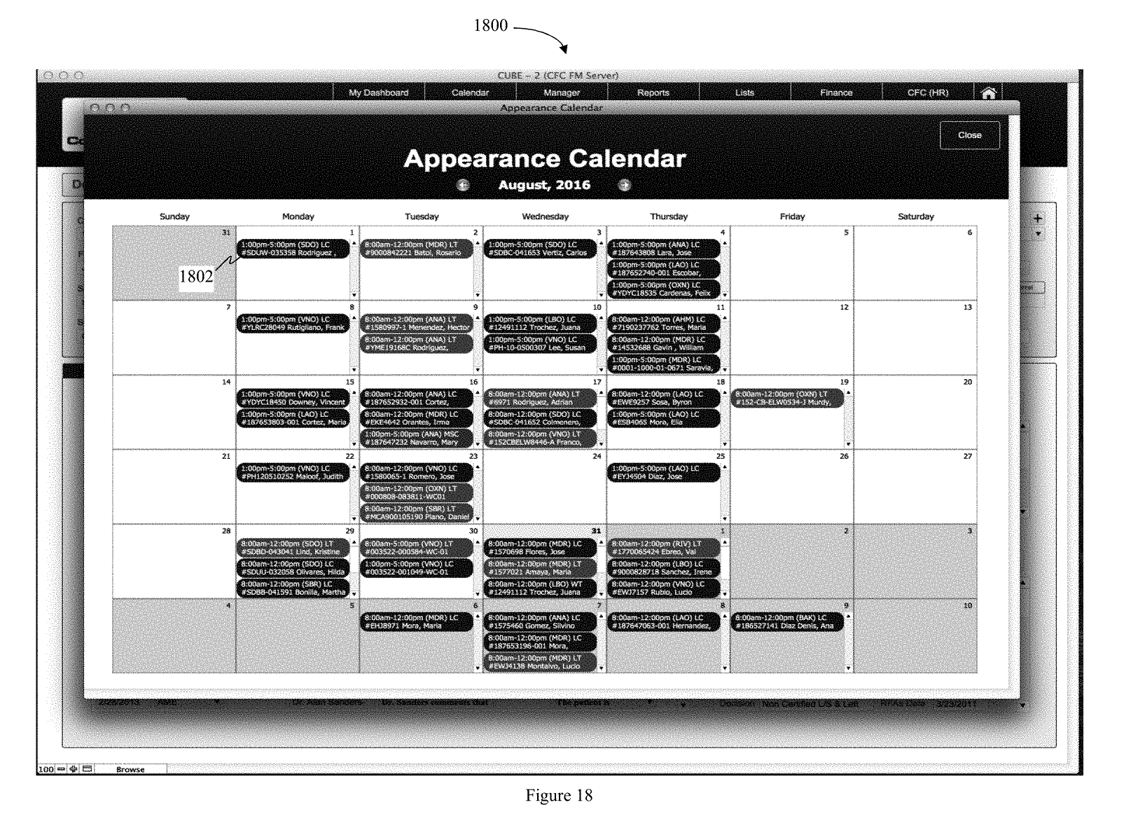

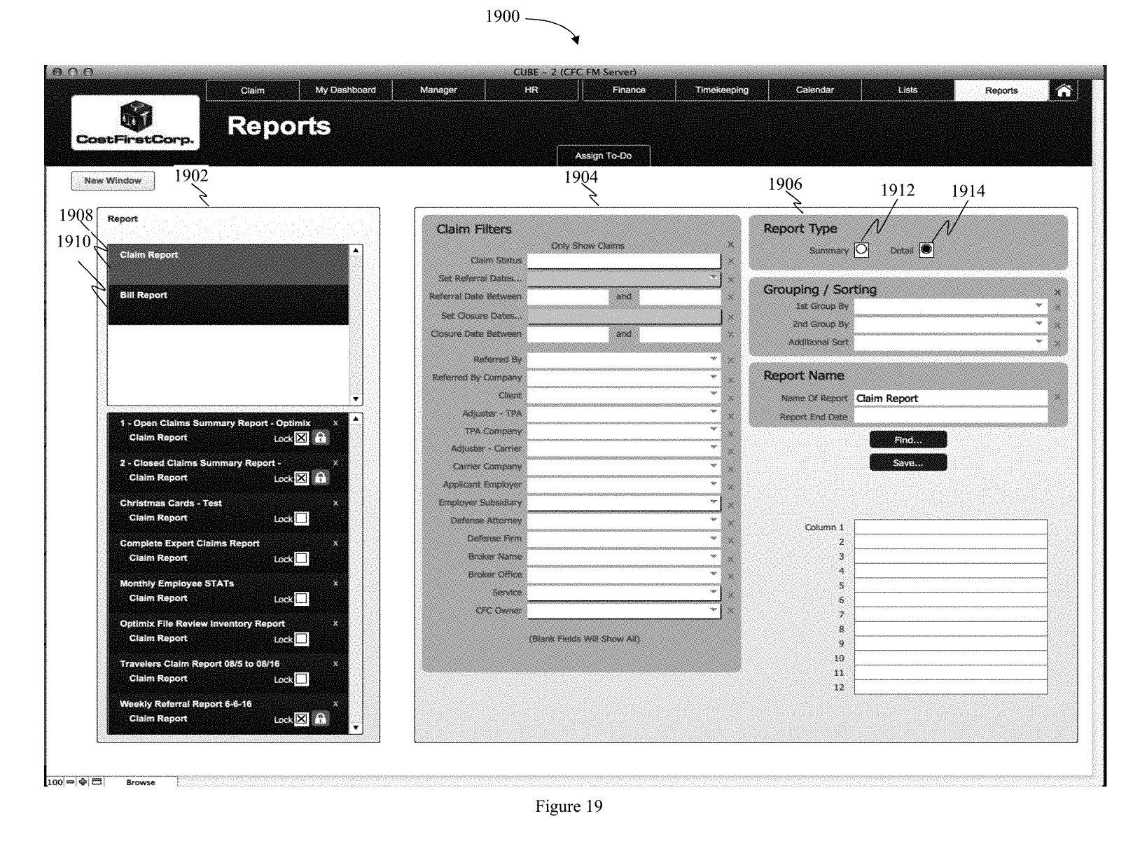

Referring now to FIG. 18, there is shown a screenshot of a hearing appearance calendar module 1800 for the system 300. The hearing appearance calendar module 1800 comprises a typical calendar with links 1802 to the matter data and displaying the date/time of one or more than one hearing. Staff can easily review their hearing dates and time and can quickly access all the documentation and data related to the matter by selecting the appropriate date/time link 1802.

Referring now to FIG. 19, there is shown a screenshot 1900 of the reporting module 318 for the system 300. The reporting module 318 comprises instructions to prepare reports for users, clients, attorneys and others that need printed documentation to resolve a claim, lien or other related matter. A variety of reports 1902 and filters 1904 can be processed by the system 300. In this embodiment, the user can select between a claims report 1908 and a bill report 1910 to be output by the system 300. Once the user selects the report type, then the user can select the filters 1904 to reduce the information that is displayed, printed or displayed and printed in the report. The user can then select if the report is to be a summary report 1912 or a detailed report 1914. Next, the user selects the grouping/sorting features for the report. Although the grouping/sorting is optional, it can save a lot of time and make the report more user friendly. Finally, the user can name the report to be displayed, printed or displayed and printed. Alternatively, the report can be saved in the system 300 for later use. Optionally, the user can create a report template using the reporting module 318 and it can be recalled by the system 300 for repeated use. This also save a great amount of time over currently available systems that do not provide repeatable reports that produce the same results over and over.

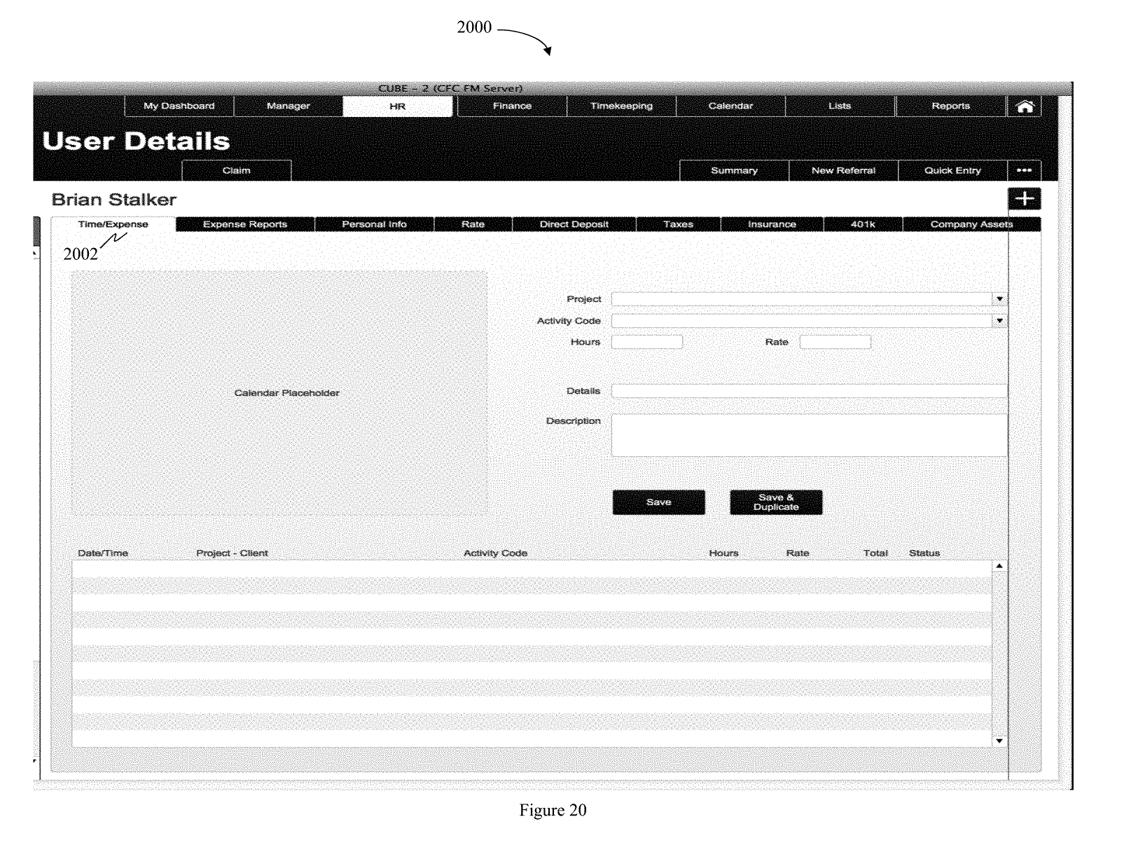

Referring now to FIG. 20, there is shown a screenshot of an accounting module 2000 for the system 300. A user with the proper access can enter time/expense information 2002 in the accounting module 2000. Other tabs, such as, for example, the Personal Info tab, will only display the user's personal information to the user and to authorized management personnel for security. A detailed account of time spent on a matter is kept here for billing and payment purposes. The user can see their benefits as they accrue and payroll can be calculated by the system 300 for processing.

What has been described is a new and improved system and method for a uniform workers' compensation cost containment system for creating a strategic plan for resolving all aspects of a one or more than one claim in an efficient manner and maximizing savings, overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

What is claimed is:

1. A uniform workers' compensation cost containment computing system for creating a strategic plan for resolving all aspects of a one or more than one claim in an efficient manner and maximizing savings, the computing system comprising:
a) one or more than one processor; and
b) a storage communicatively coupled to the one or more than one processor comprising instructions that when executed by the one or more than one processor cause the system to:
1) display a graphical user interface dashboard to a user for a uniform workers' compensation cost containment system,
where a user is selected from the group consisting of a local user and a remote user;
2) execute instructions for a global module is communicatively coupled to the processor and the storage;
3) execute instruction for a claims module is communicatively coupled to the processor and the storage;
4) execute instruction for a user module is communicatively coupled to the processor and the storage;
5) execute instruction for a tracking module is communicatively coupled to the processor and the storage;
6) execute instruction for a document module is communicatively coupled to the processor and the storage;
7) execute instruction for a calendar module is communicatively coupled to the processor and the storage; and
8) execute instruction for a reporting module is communicatively coupled to the processor and the storage.

2. The system of claim 1, where the data displayed on the dashboard is based on the user's respective activities and permissions.

3. The system of claim 1, where the dashboard is displayed via a web browser.

4. The system of claim 1, where the global module comprises instructions executable on the one or more than one processor to access the storage and to track and authenticate users, groups, and administrators.

5. The system of claim 1, where the global module further comprises instructions for:
a) data migration of existing bill log data to be imported into the system;
b) layout design specifications for the client to select required or preferred colors/color schemes and screen resolution(s);
c) global navigation of the dashboard using a displayed header; and
d) local navigation using a sidebar.

6. The system of claim 1, where the claims module comprises tables stored in the storage to manage core data needed to track and manage clients, contacts, liens and claims; including the providers and staff that are associated with the core data.

7. The system of claim 1, where the claims module further comprises layouts for the data, where the layouts comprise:
a) a claims list view of all claim records in the system; and
b) a claims table that contains developer layout that will have all claims fields.

8. The system of claim 1, where the claims module further comprises instructions executable on the one or more than one processor to:
a) add a new claim by creation of new claim record;
b) upload claim documents;
c) view claim documents;
d) request a provider;
e) import liens;
f) advance the claim to another department;
g) a bills portal that displays related bill records;
h) a claim notes portal that displays related claim notes records;
i) a companion claims portal that displays related companion claim records;
j) a product select portal, where the user can select available products for this claim;
k) a call log portal that displays related call log records;
l) an automatic plan of action generator;
m) a bill log portal that displays related bill log records;
n) a status assignment for the claim; and
o) a claim notes table, where the claim notes table comprises data relevant to the claim note.

9. The system of claim 1, where the user module comprises instructions executable on the one or more than one processor to:
a) add a new staff record;
b) assign a role to staff member;
c) assign a privilege set, where the privilege set controls the level of user access to the system;
d) create a password;
e) create an account;
f) remove a user; and
f) maintain an activities table that comprises data relevant to a specific activity assigned to a staff member.

10. The system of claim 1, where the tracking module comprises all data related phone and time tracking for employees, activities, liens and claims.

11. The system of claim 1, where the document module comprises all the data related documents stored in the system and fields for internal tracking and instructions for automatically building relationships to other tables.

12. The system of claim 1, where the calendar module comprises all the data related to calendar items for appearances including:
a) a code;
b) a litigation calendar table, where the litigation calendar table comprises data relevant to specific calendar entries including:
1) a judge;
2) an assigned representative;
3) total appearances that is a count of appearance records;
4) an outcome;
5) an appearance needed flag that is a Boolean value with 1 representing yes and 0 representing no;
6) a calendar interface table comprising data relevant to general interface items on the calendar, such as day, week, month, year and sorting;
7) a claim number;
8) a last name; and
9) a first name.

13. The system of claim 1, where the reporting module comprises all the data related to generating report documents that will be exported from the system.

14. The system of claim 1, where reporting module also comprises instructions for automatically creating a plan of action.

15. A computer-implemented method of a uniform workers' compensation cost containment system for creating a strategic plan for resolving all aspects of a one or more than one claim in an efficient manner and maximizing savings, the method comprising the steps of:
a) providing the system of claim 1;
b) providing instructions stored on a storage executable on one or more than one processor having a memory for a uniform workers' compensation cost containment system for creating a strategic plan for resolving all aspects of a one or more than one claim in an efficient manner and maximizing savings;
c) receiving a referral for a claim from a client;
d) identifying all areas of workers' compensation that the referral applies too;
e) evaluating the claim, where the evaluation comprises instructions executable on a processor for:
1) generating a plan of action, lien analysis or both a plan of action and a lien analysis;
2) generating a provider compliance unit (PCU)/special investigation unit analysis;
3) generating a Lien Type analysis; and
4) generating a bill log;
e) automatically reviewing all claims for an explanation of benefits;
f) outputting a plan to negotiating settlements to resolve all bills, whether a lien has been filed or not;
g) presenting to the client an ongoing management of claims using a computerized user interface dashboard, where the dashboard presents one or more than one report reflecting all providers for one or more than one claim through resolution of the one or more than one claim;
h) monitoring, tracking or both monitoring and tracking a Workers' Compensation Appeals Board calendar for hearings dates for each claim and automatically identify one or more than one representative that can attend; and
i) identifying, sorting or both identifying and sorting the one or more than one claim by criteria,
where the criteria comprise:
1) a provider;
2) a lien type;
3) a lien defense;
4) a SIU (investigative tool);
5) a settled/not-settled status; and
6) a provider with same tax id numbers,
to help improve efficiencies and monitoring.

16. The method of claim 15, further comprising the step of representing a client at a Workers' Compensation Appeals Board during a hearing or a conference as a hearing representative to settle, litigate or negotiate liens.

17. The method of claim 15, further comprising the step of representing the client at a Workers' Compensation Appeals Board during a hearing or trial as an expert witness to move forward in trial setting.

18. A method for a uniform workers' compensation cost containment system for creating a strategic plan for resolving all aspects of a one or more than one claim in an efficient manner and maximizing savings, the method comprising the steps of:
a) receiving a referral, a collection of bills or an entire claim for bill review, resolution or both bill review and resolution of all outstanding bills related to a specific insurance claim;
b) analyzing the referral using an intake module to determine the service requested, documents provided, identify additional documents required, process required documents, and to create a bill log;
c) reviewing all relevant bills to input into the system;
d) executing instructions to review all bills in detail, including analysis of any related reports to determine proper official medical fee schedule;
e) performing a detailed analysis of all file documentation, developing a detailed plan of action, initiating resolutions of bills/liens with a provider, a collection agency or both a provider and a collection agency
f) scheduling personnel to attend the conference on behalf of a client to present arguments to a judge if required, and negotiate settlement of bill/lien in effort to fully resolve claim; and
g) automatically processing all invoices on a monthly basis, when a claim is closed or both a monthly basis and when a claim is closed.

19. The method of claim 18, further comprising the step of providing information for an initial WCAB hearing to present information to WCAB judge.

20. The method of claim 18, further comprising the step of automatically scheduling an expert witness to attend WCAB trial.
